(19) United States
(12) Patent Application Publication
(10) Pub. No.: US 2016/0085258 A1
(43) Pub. Date: Mar. 24, 2016

(54) SELECTOR LEVER WITH FAILURE INDICATION FEATURES

(71) Applicant: Hamilton Sundstrand Corporation, Windsor Locks, CT (US)

(72) Inventors: Cory M. Crandall-Seibert, Roscoe, IL (US); Andrew N. Baines, Rockton, IL (US); Timothy Michael Mayer, Belvidere, IL (US); Gary L. Voss, Bryon, IL (US); Sean Bradshaw, Rockford, IL (US); Roger F. Glenn, South Beloit, IL (US)

(21) Appl. No.: 14/495,006

(22) Filed: Sep. 24, 2014

(51) Int. Cl. G05G 25/00; G05G 5/06; B64C 13/14; G05G 1/04

(52) U.S. Cl. CPC G05G 25/00; G05G 1/04; G05G 5/06; B64C 13/14

(57) ABSTRACT

A selector lever with redundant detent pins and detent plates and a method for using the selector lever to test for a failure of one or more detent pins. The detent plates include a plurality of slots connected by a channel that corresponds to a disengaged position, enabling the detent pin to be moved from one slot to another. The selector lever includes one or more obstructing features in the channels of the detent plates. The selector lever further includes indicators for comparing the location of the shaft with the location of the obstructing features while the slide is in the disengaged position.

### BACKGROUND OF THE INVENTION

The present disclosure relates generally to selector levers and, more particularly, to a failure detection mechanism for selector levers that may be found, for example, in the cockpit of an aircraft.

Conventional aircraft are commonly equipped with a selector lever for manually controlling the actuation of flaps, ailerons, or other moveable features of the aircraft. The selector lever is mounted in the cockpit for the pilot to select the desired equipment configuration by moving the lever to a position corresponding to the desired equipment configuration. The conventional selector lever is typically constructed with a shaft rotatably arranged adjacent one or two detent plates. One or two detent pins corresponding to the detent plates are movably arranged on the shaft. This configuration provides a measure of redundancy that allows the selector lever to be functional after one detent pin has failed. The ability to detect the failure of one or both detent pins would reduce maintenance costs and improve aircraft safety. Accordingly, the industry is receptive to new developments that provide the capability to detect the failure of a detent pin.

### SUMMARY OF THE INVENTION

Disclosed herein is a selector lever having a shaft with a proximal end disposed in a housing and a distal end extending from the housing. A slide arranged to be movable along the shaft with a first detent pin and a second detent pin operatively connected to the slide. A first detent plate is disposed in the housing and arranged to receive the first detent pin, having a first plurality connected by a first channel. The first channel containing one or more first obstructing features. A second detent plate is disposed in the housing and having a second plurality of slots for receiving the second detent pin, the second plurality of slots being connected by a second channel. The second channel contains one or more second obstructing features, wherein the second plurality of slots are arranged to align with the first plurality of slots. The one or more second obstructing features are arranged to be not aligned with the one or more first obstructing features

Another aspect of the disclosure provides a method of detecting the failure of a selector lever.

### BRIEF DESCRIPTION OF THE DRAWINGS

The following descriptions should not be considered limiting in any way. With reference to the accompanying drawings, like elements are numbered alike:

FIG. 1 is an illustration of an aircraft according to one embodiment;

FIG. 2 is a sectioned front view of a selector lever according to one embodiment;

FIG. 3A is a sectioned side view of the selector lever shown in FIG. 2;

FIG. 3B is a partial top view of the selector lever shown in FIG. 3A;

FIG. 4A is a sectioned side view of a selector lever according to another embodiment; and

FIG. 4B is a partial top view of the selector lever shown in FIG. 4A.

### DETAILED DESCRIPTION OF THE INVENTION

A detailed description of one or more embodiments of the disclosed apparatus and method are presented herein by way of exemplification and not limitation with reference to the Figures. It is to be understood that other embodiments may be utilized and changes may be made without departing from the scope of the present disclosure. In particular, the disclosure provides various examples related to a selector lever for aircraft, whereas the advantages of the present disclosure as applied in a related field would be apparent to one having ordinary skill in the art and are considered to be within the scope of the present invention.

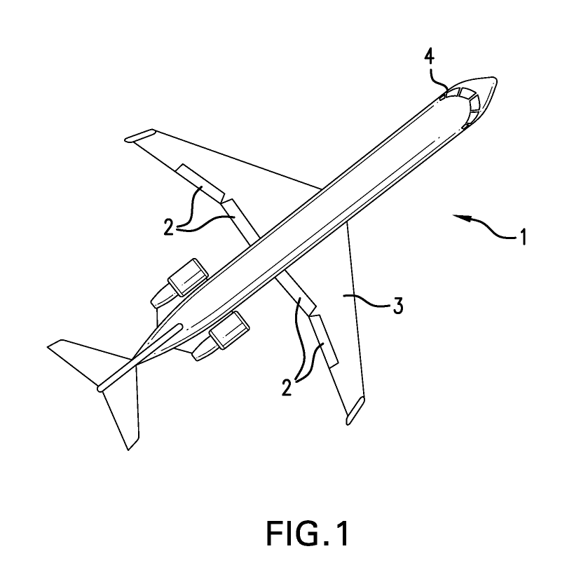

FIG. 1 shows a top view of an aircraft 1 having an aircraft actuator system that employs the selector lever of the present disclosure. For example, the selector lever of the aircraft actuator system may be used to control the position of a plurality of flaps 2 located on the wings 3 of the aircraft 1. The selector lever enables the operator (or pilot) to accurately control the position of the flaps 2 from the cockpit 4. As noted above, the selector lever is contemplated to control the position of various control surfaces, such as the flaps of an aircraft. Specifically, the selector lever is contemplated to be employed in connection with one or more of the high lift surfaces associated with an aircraft. The selector lever may find other uses, in differing environments, without departing from the scope of the present disclosure.

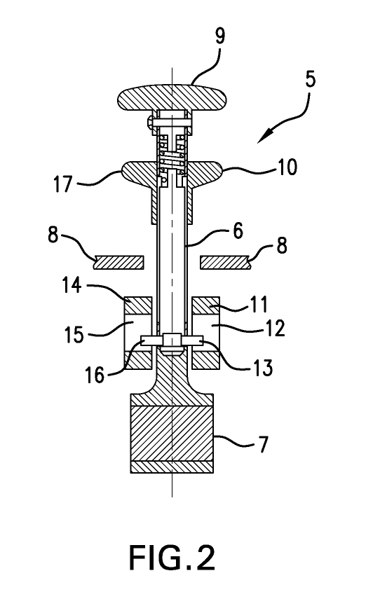

FIG. 2 is a sectioned front view of a hand-operated selector lever 5 according to one embodiment of the present disclosure. The selector lever 5 includes a shaft 6 having a proximal end that is rotatably attached to a pivot 7 that is disposed in a housing 8. The shaft 6 also comprises a distal end 9 that extends from the housing 8. A slide 10 is arranged to move along the shaft 6, the slide 10 at least partially extending from the housing 8.

FIG. 2 shows a first detent plate 11 with a plurality of slots 12 disposed in the housing 8 parallel to the path of the pivoting shaft 6. FIG. 2 further shows a first detent pin 13 arranged on the shaft 6 to engage the first plurality of slots 12 of the first detent plate 11. The first detent pin 13 is operatively connected to the slide 10 such that translational movement of the slide 10 along the shaft results in movement of the first detent pin 13.

The selector lever 5 further comprises a second detent plate 14, (having a second plurality of slots 15), arranged opposite from the first detent plate 11. Further, a second detent pin 16 is arranged on the shaft 6 to engage the second plurality of slots 15 of the second detent plate 14, the second detent pin 13 being operatively connected to a second slide 17, the second slide capable of being operated independently from the slide 10. The second detent plate 14 and second detent pin 16 mirror the first detent plate 11 and first detent pin 13.

FIG. 2 shows the selector lever 5 with the slide 10 in an engaged position. The “engaged position” refers to the position of the slide 10 when the first and second detent pins 13, 16 are inserted into one of the first or second plurality of slots 12, 15, respectively. A disengaged position of the slide 10 refers to the position of the slide when the respective first or second detent pin 13, 16 is withdrawn from the respective slot. Where the slide 10 is in the disengaged position, the shaft 6 may be rotated about the pivot 7 to a desired position of the shaft. The slide 10 can then be moved to the engaged position, which when at least one of the detent pins 13, 16 is intact, will effectively lock the shaft 6 in place.

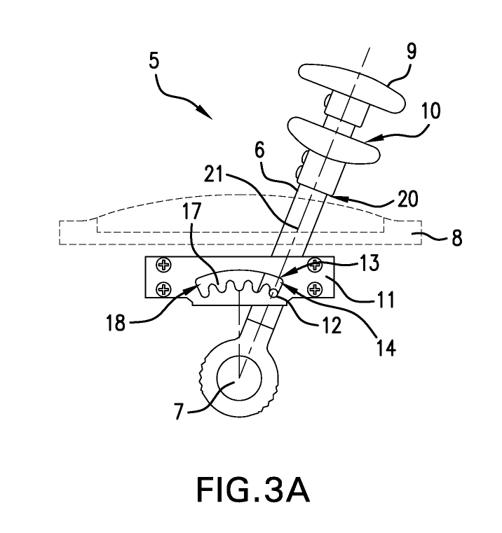

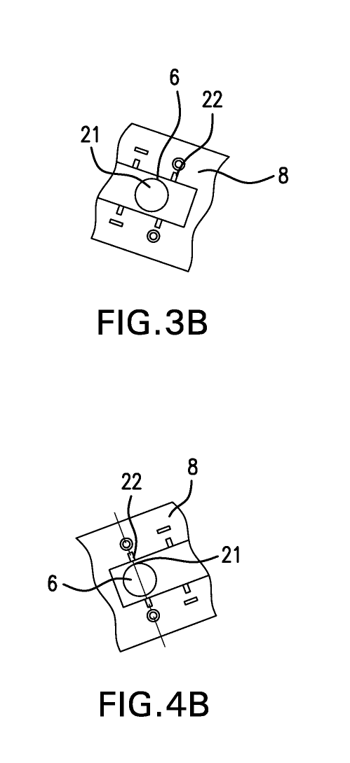

FIG. 3A illustrates the selector lever 5 facing the first detent plate 11. The detent plate 11 includes a channel 17 through which the first detent pin 13 is free to travel while in the disengaged position. Accordingly, the disengaged position of the embodiment illustrated in FIG. 3A corresponds to a radial position of the first detent pin 13 that is complemented by the arrangement of the channel 17. The second detent plate 14 (see FIG. 2) also contains a similar channel. The channel 17 may be a configured at a radius from the pivot 7 corresponding to the disengaged position. The selector lever 5 may also comprise a disengaged indicator 20 that provides a visual indication to the operator that the selector lever is disengaged and that the detent pin 13 is thereby positioned in the channel 17.

The selector lever 5 further includes one or more obstructing features in the channel 17 of one or both detent plates to test for a detent pin failure. A first obstructing feature 18 is placed in the channel 17 of the first detent plate 11, shown at one end of the channel 17. A second obstructing feature 19 is placed in the channel 17 of the second detent plate 14. The obstructing features 18, 19 are placed at different locations in the channels 17 of the respective detent plates 11, 14. The obstructing features 18, 19 may, for example, be formed as force ramps at the ends of the channel 17 (as shown), but may also be gates, ramps at other locations in the channel 17, or tactile sections including bumps that would be felt by the operator while moving the shaft 6 through the obstructing features 18, 19 while the respective detent pins 13, 16 are intact. The selctor lever 5 may include a plurality of obstructing features 18, 19 on each detent plate 11, 14. The first obstructing feature 18 of the first detent plate 11 should not be aligned with the second obstructing feature 19 of the second detent plate 14. This arrangement allows the operator to test for a failure of the detent pins 13, 16 individually.

FIG. 3B shows an alignment indicator 21 on the shaft, which is useful in determining the position of the shaft with respect to the obstructing features while moving the detent pins 13, 16 through the channel 17. FIG. 3B further shows a corresponding position indicator 22 located on the housing 8. The position indicator may, for example, be arranged directly above one or more of the obstructing features 18, 19.

The selector lever 5 may also comprise one or more biasing elements. For example, a first biasing element biases the first slide towards an engaged position and a second biasing element biases the second slide towards an engaged position.

The selector lever 5 of the present disclosure may be used to test the whether the detent pins 13, 16 remain intact. The detent pins 13, 16 are tested individually, without removing the housing 8 or requiring other maintenance procedures. For example, when moving the shaft 6 from one position to another, the operator can judge the integrity of the detent pins 13, 16 by observing the respective indicators 20, 21, 22.

FIGS. 3A and 3B illustrate the selector lever 5 in a position to test the second detent pin 16. First, the operator moves the shaft 6 to position the first detent pin 13 at the location of the second obstructing feature 19. The operator moves the shaft 6 towards the position of the second obstructing feature 19, keeping the slide 10 in the disengaged position, as shown by the presence of the disengaged indicator 20. With the slide 10 held in the disengaged position, the operator will be unable to move the shaft into the location of the second obstructing feature 19 while the second detent pin 16 is intact. This position is shown in FIG. 3B, where the alignment indicator 21 does not align with the position indicator 22. Thus, if the operator is unable to move the shaft 6 to align the alignment indicator 21 with the position indicator 22 while the disengaged indicator 20 is visible, the operator may conclude that the respective detent pin is intact.

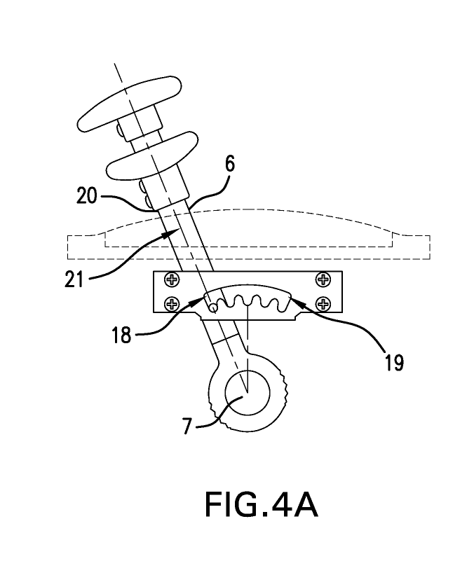

The same procedure may then be used to determine the integrity of the remaining detent pin. For example, FIGS. 4A and 4B illustrate the selector lever 5 of the present disclosure where the first detent pin 13 is proven to have failed. As with the example of FIGS. 3A and 3B, the operator moves the shaft 6 towards the position of the first obstructing feature 18, while maintaining the slide 10 in the disengaged position, as shown by the presence of the disengaged indicator 20. With the first detent pin 13 having failed, the operator is able to align the alignment indicator 21 with the position indicator 22, as shown in FIG. 4B.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc., do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A selector lever, comprising:
a shaft having a proximal end disposed within a housing, the shaft having a distal end extending from the housing;
a slide arranged to be movable along the shaft;
a first detent pin operatively connected to the slide;
a second detent pin operatively connected to the slide;
a first detent plate disposed in the housing and having a first plurality of slots for receiving the first detent pin, the first plurality of slots connected by a first channel, the first channel containing one or more first obstructing features; and
a second detent plate disposed in the housing and having a second plurality of slots for receiving the second detent pin, the second plurality of slots being connected by a second channel, the second channel containing one or more second obstructing features, wherein the second plurality of slots are arranged to align with the first plurality of slots, and wherein the one or more second obstructing features are arranged to be not aligned with the one or more first obstructing features.

2. The selector lever of claim 1, wherein the one or more first obstructing features and the one or more second obstructing features includes one or more force ramps.

3. The selector lever of claim 1, wherein the one or more first obstructing features and the one or more second obstructing features includes one or more tactile features.

4. The selector lever of claim 1, the proximal end of the shaft being rotatably attached to a pivot.

5. The selector lever of claim 1, further comprising a disengaged indicator arranged on the shaft.

6. The selector lever of claim 1, further comprising an alignment indicator arranged on the shaft and one or more position indicators arranged on the housing, the one or more position indicators being arranged at a location corresponding to one of the first or second obstructing features.

7. The selector lever of claim 1, further comprising a biasing element arranged to bias the slide towards an engaged position.

8. A method of detecting the failure of a selector lever, comprising:
placing a in a disengaged position along a shaft, the first slide operatively connected to one or more detent pins, the disengaged position corresponding to locating the one or more detent pins in a channel within a one or more detent plates;
moving the shaft into a position corresponding to an obstructing feature located in the channel; and
determining whether or not the one or more detent pins has failed by evaluating the position of the shaft relative to the location of the obstructing feature while the slide is in the disengaged position.

9. The method of claim 8, wherein the step of determining whether or not the one or more detent pins has failed includes exerting a force on the shaft to move the one or more detent pins into the location of the one or more obstructing features.

10. The method of claim 8, wherein the step of determining whether or not the one or more detent pins has failed includes comparing the location of an alignment indicator with the location of a position indicator while the slide is in a disengaged position.
